(19) United States
(12) Patent Application Publication
(10) Pub. No.: US 2002/0060666 A1
(43) Pub. Date: May 23, 2002

(54) Method and apparatus for computer mouse with guide fin and remote switching means

(76) Inventors: J. Garth Close, Georgetown, TX (US); Bob Dale Rufenacht, Casper, WY (US)

Correspondence Address: BOB D. RUFENACHT, DALE-LEE, INC., PO BOX 51307, CASPER, WY, 82605, US

(21) Appl. No.: 10/035,751

(22) Filed: Oct. 27, 2001

Related U.S. Application Data
(60) Provisional application No. 60/238,780, filed on Oct. 10, 2000.

(51) Int. Cl. G09G 5/08

(52) U.S. Cl. 345/163

(57) ABSTRACT

A Computer mouse with a non-clasping guide fin or guide pins in combination with a secondary switch. The secondary switch may be hard-wired or wireless. The mouse guide may be operated with one hand while the mouse “clicking” functions are performed by a second hand or other method including voice activation.

### RELATED APPLICATIONS

This application is related to, and claims priority from, Provisional Patent 60/238,780, “Remote Clicker and Control Fin” by Garth Close filed Dec. 13, 2000.

### BACKGROUND OF THE INVENTION

1. Field of the Invention

The field of the invention relates to a computer control apparatus, and more particularly, to a modified mouse input device.

2. Description of the Prior Art

The prior art includes several references to multiple input devices. U.S. Pat. No. 4,816,810, issued on Mar. 28, 1989, to Moore, describes the use of a mouse and a secondary switch so that the left click operation on mouse can either be performed on the mouse or on the second switch. This device, however, is applied only to override (or bypass) the left mouse ‘clicker’ by splicing a special coupler into the multistrand wire itself. Thence, wiring in an extra circuit to and from the secondary moment switch itself. The switch is particularly useful for graphical applications where it is desirable to invoke the mouse function without moving the mouse, because even the slightest mouse movement would cause the cursor to move from a desired location.

U.S. Pat. No. 4,594,683 issued in June 1986, to Frank, describes a keyboard of the type known in connection with computer input equipment. To this keyboard has been added an additional row of keys to use in operations particularly required in the case of operation by blind and partially sighted people. This row of keys can be replaced by a single shift key, so that after operating the latter, the individual input keys can be used as function keys.

U.S. Pat. No. 5,621,435 issued in April, 1997, to Krivacic, describes an application pertaining to the art of human-machine interfaces, and more particularly to a computer terminal graphical user interface which allows for added control by an operator's non-dominant hand. The invention is stated to be particularly applicable to computer aided design or drafting, and is described with particular reference thereto.

U.S. Pat. No. 5,667,220 issued in September 1997, to Cheng, describes a controller for a video game console including first and second handhold control units. Each of the handhold control units has a housing with a finger-operating surface that is provided with a control button, and a transmitting unit for transmitting signals to the video game console when the control button unit is operated.

A computer mouse typically has one or two integral control buttons providing an input control method to the basic computer function system. These buttons are usually “clicked” by depressing either a right or left button once or twice. In order to use a mouse with these control buttons, it is necessary that the operator's hand grasp the mouse securely as it is moved about on a mouse pad to properly direct a cursor to a desired position on the monitor screen. During this movement, one or two fingers of the operator's same hand must be held in a ‘ready’ position to “click” a mouse button to send instructions where and when desired. Even for short-term use, this mouse control method may soon cause stress and strain on the operator's arm, wrist, and fingers. Over time, the repetitive use of a mouse can develop into very painful carpal tunnel syndrome cases, arthritic condition irritation, and the potential inability to continue certain job positions or duties.

### SUMMARY OF THE INVENTION

The current invention enables the computer operator to guide the mouse with one hand, without clasping fingers around the mouse and without holding one or more fingers of the hand in a ‘ready’ position to “click” a mouse button.

The invention includes a modified mouse where the modifications permit movement of the mouse with a control fin, which may be positioned between fingers on the hand. The modifications also include a remote secondary switching mechanism, which in various embodiments may be hand-held and activated by one or more fingers in the hand which holds the mechanism; or mounted such that the switch may be activated by a hand, foot, or other body part; or by non-contact means such as a ‘voice, or sound’ activated transmitting mechanism or device.

The operator is free to direct the mouse movement with a first hand, until the mouse is in a proper location, at which time the operator has a choice of activating a mouse button by “clicking” appropriate mouse button, or by using a second hand or other body part to activate a switch on the secondary switching mechanism. The normal “clicking” function of the mouse is still always available and useable to the operator, if so desired.

In some embodiments, a mouse is provided with an integral fin. In other embodiments, a control fin may be attached to an existing mouse.

### BRIEF DESCRIPTION OF THE DRAWINGS

The Invention may be more easily understood, and its benefits would become more apparent, with the viewing of the following drawings and sketches:

FIG. 1 is a plan view illustration of the generally accepted PC Station, consisting of the computer, the monitor, the keyboard, and the ‘mouse’ input device, together with the invention's added secondary switch wired to the mouse, and the guide fin added to the mouse.

FIG. 2 is a schematic illustration of a prior art mouse control circuit board and it's internal electrical conductive wiring.

FIG. 3 is a schematic illustration of a mouse with an alternative secondary switch for the left mouse button.

FIG. 4 is a schematic illustration of a mouse with alternative secondary switches for the left and right mouse buttons.

FIG. 5 is a schematic illustration of a mouse with a removable alternative secondary switch for the left mouse button.

FIG. 6 is a schematic illustration of a mouse with removable alternative secondary switches for the left and right mouse buttons.

FIG. 7 is a schematic illustration of a mouse with an alternative secondary switch for the left mouse button in wireless communication to the mouse left button control circuit.

FIG. 8 is a schematic illustration of a mouse with alternative secondary switches for the left and right mouse buttons in wireless communication to the mouse left and right button control circuits.

FIG. 9A is a side view of a mouse top cover with an integral guide fin.

FIG. 9B is a front view of a mouse top cover with an integral guide fin.

FIG. 9C is a top view of a mouse top cover with an integral guide fin.

FIG. 10A is a side view of a mouse top cover with integral ‘snap-on’ pegs for a guide fin.

FIG. 10B is a front view of a mouse top cover with integral ‘snap-on’ pegs for a guide fin.

FIG. 10C is a top view of a mouse top cover with integral ‘snap-on’ pegs for a guide fin.

FIG. 11A is a side view of an existing mouse top cover fitted with a guide fin.

FIG. 11B is a front view of an existing mouse top cover fitted with a guide fin.

FIG. 11C is a top view of an existing mouse top cover fitted with a guide fin.

FIG. 12A is an exploded side view of a separate guide fin before adhesive installation.

FIG. 12B is an exploded front view of a separate guide fin before adhesive installation.

FIG. 12C is a top view of a separate guide fin before adhesive installation.

FIG. 13A is an exploded side view of a separate guide fin before Velcro™, hook and eye installation.

FIG. 13B is an exploded front view of a separate guide fin before Velcro™, hook and eye installation.

FIG. 13C is a top view of a separate guide fin before Velcro™, hook and eye installation.

FIG. 14A is a side view of a separate guide fin with ‘snap-on’ facilities before installation.

FIG. 14B is a front view of a separate guide fin with ‘snap-on’ facilities before installation.

FIG. 14C is a top view of a separate guide fin with ‘snap-on’ facilities before installation.

### DETAILED DESCRIPTION

Description of Embodiment—Single Remote Secondary Switch & Guide Fin

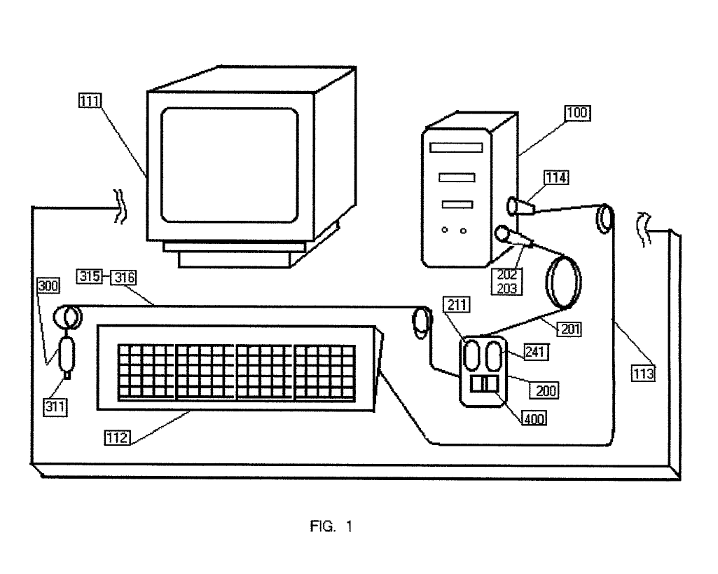

FIG. 1 illustrates a typical computer system consisting of a computer (100), a monitor (111), a keyboard (112), and a mouse (200). The keyboard is typically connected to a 6-pin PS/2 port (114) on the computer by means of a multistrand cable (113). The mouse is typically connected to a 9-pin serial port (202) or a 6-pin PS/2 port (203) on the computer by means of a multistrand cable (201). The mouse typically includes a left ‘clicker’ button (211) and a right ‘clicker’ button (241). In this embodiment, the computer system also includes a remote secondary switch (300) so that the left button functions of the mouse may either be performed on the mouse (200) or on its the secondary switch button (311), and, subsequently through electrical wires (315) and (316). Also in this embodiment, the computer system mouse (200) includes an add-on finger control fin (400) to enable easy movement of the mouse without a firm constant grasp by the dominant hand.

Description of Embodiment—Internal Switches and Wiring of Usual Computer Mouse

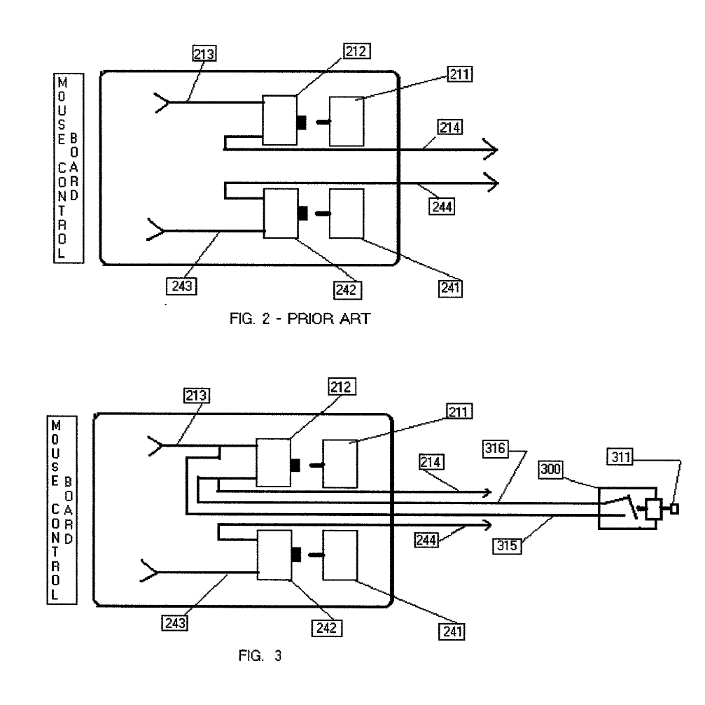

FIG. 2 illustrates the prior art mechanism on the circuit board inside a standard computer Mouse (200) that gives instructions to the computer function system whenever the Mouse has properly positioned the cursor as desired. If the left hand clicker (211) is depressed, the moment switch (212) closes a circuit in the computer electrical conductor system from wire (213) to wire (214) directing the function system to perform a certain task. When clicker (211) is released, moment switch (212) reopens and breaks that circuit, until the process needs to be repeated as desired. The same relationship holds true for right hand clicker (241) and moment switch (242) and computer electrical conductor system wires (243) and (244).

Description of Embodiment—Hard Wired Left Hand Secondary Switch

FIG. 3 illustrates a modification to the prior art standard board design. When button (311) is depressed on secondary moment switch (300), it allows electrical control wire (315) to close a circuit with wire (316) and thence to wire (214) bypassing left hand ‘clicker’ (211) and moment switch (212), and directs the function system to perform the desired task. When moment switch button (311) on secondary switch (300) is released, it reopens, and the circuit is broken as before, awaiting to be repeated as desired. Right hand ‘clicker’ (241) and moment switch (242) and computer electrical conductor system wires (243) and (244) remain unchanged.

Description of Embodiment—Hard Wired Left and Right Hand Secondary Switch

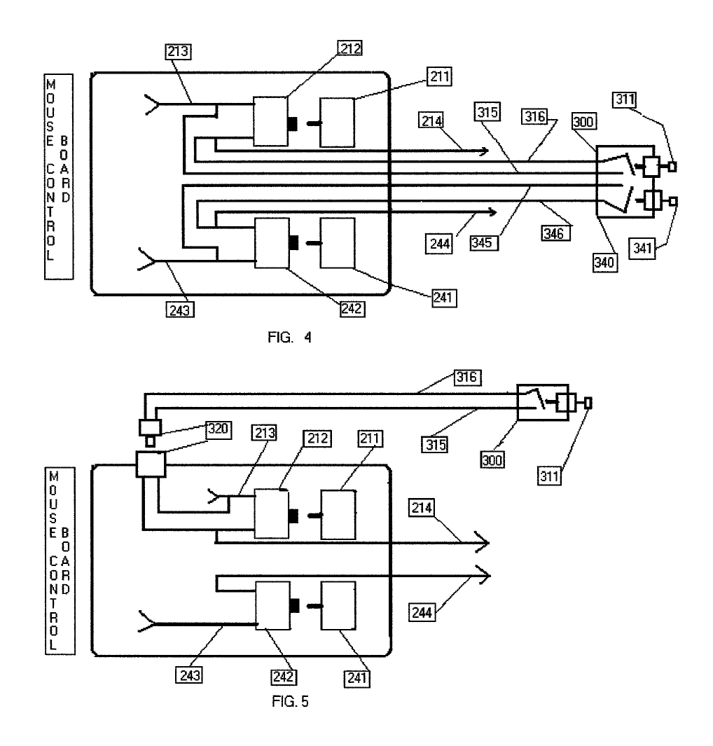

FIG. 4 illustrates another modification to the prior art standard board design. When button (341) is depressed on secondary moment switch (340), it allows electrical control wire (345) to close a circuit with wire (346) and thence to wire (244) bypassing right hand ‘clicker’ (241) and moment switch (242), and directs the function system to perform the desired task. When either button (311) on secondary moment switch (300), or button (341) on secondary moment switch (340) is released, they reopen respectively, and the related circuit is broken as before, awaiting to be repeated as desired.

Description of the Embodiment—Removable Left Hand Secondary Switch

FIG. 5 illustrates another modification the prior art that standard board design. When button (311) is depressed on secondary moment switch (300), it allows electrical control wire (315) to close a circuit with wire (316) and thence through coupler (320) and on through wire (214) bypassing left hand ‘clicker’ (211) and moment switch (212), and directs the function system to perform the desired task. When moment switch button (311) on secondary switch (300) is released, it reopens, and the circuit is broken as before, awaiting to be repeated as desired. Right hand ‘clicker’ (241) and moment switch (242) and computer electrical conductor system wires (243) and (244) remain unchanged.

Description of Embodiment—Removable Left and Right-Hand Secondary Switches

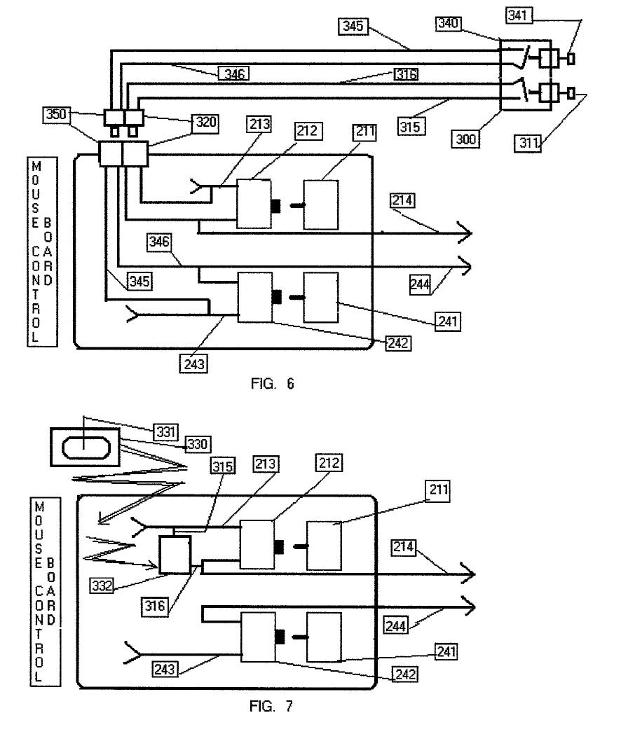

FIG. 6 illustrates another modification to the prior art standard board design. When button (341) is depressed on secondary moment switch (340), it allows electrical control wire (345) to close a circuit with wire (346) and thence through coupler (350) and on through wire (244) bypassing right hand ‘clicker’ (241) and moment switch (242), and directs the function system to perform the desired task. When either moment switch button (311) on secondary switch (300) or moment switch button (341) on secondary switch (340) is released, they reopen respectively, and the related circuit is broken as before, awaiting to be repeated as desired.

Description of Embodiment—Wireless Signal Transmitter and Receiver for Left Hand Secondary Switch

FIG. 7 illustrates another modification to the prior art standard board design. When button (331) is depressed on ‘wireless’ remote transmitter (330) a signal is send to internal receiver (332) which closes a circuit between wire (315) and wire (316) and thence to wire (214) bypassing left hand ‘clicker’ (211) and moment switch (212), and directs the function system to perform the desired task. When button (331) is released on ‘wireless’ remote transmitter (330), it stops transmitting, and receiver (332) breaks the circuit as before, awaiting to be repeated as desired. Right hand ‘clicker’ (241) and moment switch (242) and computer electrical conductor system wires (243) and (244) remain unchanged.

Description of Embodiment—Wireless Signal Transmitters and Receivers for Left Hand and Right Secondary Switches

FIG. 8 illustrates another modification to the prior art standard board design. When button (361) is depressed on ‘wireless’ remote transmitter (360) a signal is send to internal receiver (362) which closes a circuit between wire (345) and wire (346) and thence to wire (244) bypassing right hand ‘clicker’ (241) and moment switch (242), and directs the function system to perform the desired task. When either button (331) on ‘wireless’ transmitter (330) or button (361) on ‘wireless’ transmitter (360) is released, it stops transmitting, and receiver (332) or receiver (362) respectively breaks the circuit as before, awaiting to be repeated as desired.

Description of Embodiment—Mouse Top Cover with Molded Integral Guide Fin

FIGS. 9A-C illustrate a modification to any standard mouse top cover (204) with an integral control fin (400) molded into the basic design to enable a computer operator's interfingers to slide over the fin and control the movement of the mouse (200). The location of the fin on this top cover is on the longitudinal centerline of the mouse with it's front edge beginning approximately ¼″ back from the rear edge of the usual mouse ‘clicker’ buttons. The perpendicular height of the fin is approximately ¾″ from the top of the cover, and the fin width is approximately ⅞″ and it's thickness approximately ⅛″.

Description of Embodiment—Mouse Top Cover with Molded ‘Snap-On’ Pegs

FIGS. 10A-C illustrate a modification to any standard mouse top cover (204) with ‘snap-on’ buttons (401) molded into the top cover's basic design for installing a removable ‘snap-on’ control fin (400). The term guide fin refers to both a solid fin and to one or more pegs. It is envisioned that preferably a minimum of four ‘snap-on’ pins are located in a horizontal centerline across the mouse cover approximately 9/16″ back from the rear edge of the usual ‘clicker’ buttons, spaced approximately ⅝″ apart, with a diameter of approximately 3/32″, and are approximately 5/32″ high with a very slightly bigger ball-type enlargement at their top.

Description of Embodiment—Mouse with Removable Control Fin

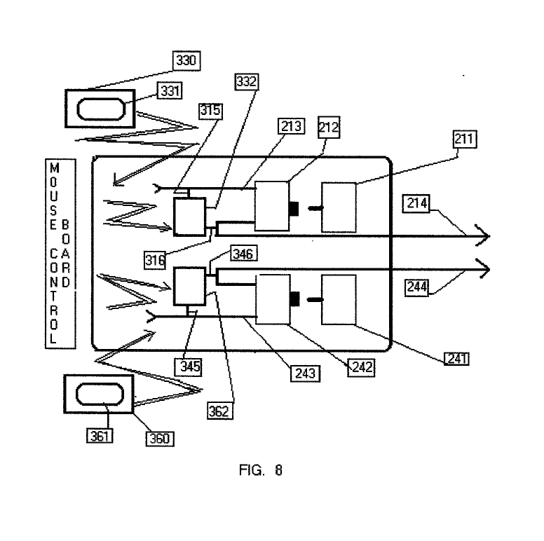

FIGS. 11A-C illustrate a modification to any standard mouse top cover (204) with removable control fin (400) installed to enable a computer operator's interfingers to slide over the fin and control the movement of the mouse (200). The vertical portion of the control fin is approximately ¾″ high, with a width of ⅞″, and a thickness of ⅛″. Attached to, and made part of the vertical fin, is a horizontal pad extending equally on each side consisting of a ⅞″ square, with a thickness of not more than ⅛″, to which the mounting adhesive or Velcro™ is attached, or the corresponding ‘snap-on’ holes are drilled.

Description of Embodiment—Removable Guide Fin—Self Adhesive

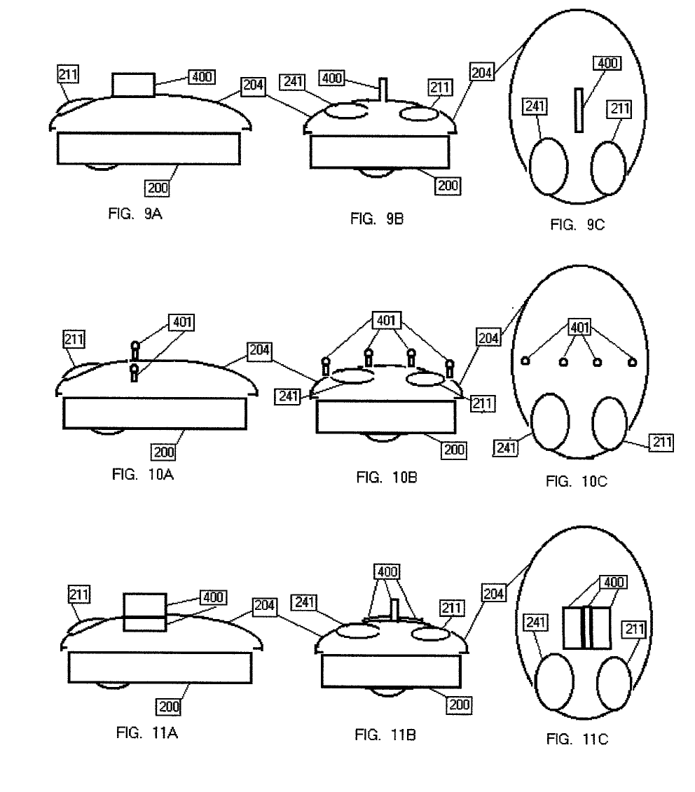

FIGS. 12A-C: illustrate the design of control fin (400) with self adhesive pad (411) pre-applied to the underneath flaps of control fin so that an adhesive backing sheet may be removed from the flaps, and the flaps pressed against the top cover (204) of the mouse for secured mounting. The vertical portion of the control fin is approximately ¾″ high, with a width of ⅞″, and a thickness of ⅛″. Attached to, and made part of the vertical fin, is a horizontal pad extending equally on each side consisting of a ⅞″ square, with a thickness of not more than ⅛″, to which the mounting adhesive is attached.

Description of Embodiment—Removable Guide Fin—Velcro™ Hook and Eye

FIGS. 13A-C illustrate the basic design of control fin (400) with self adhesive Velcro™ hook pad (412) pre-applied to the underneath flaps of control fin, and furnished with self adhesive Velcro™ eye pad (413) so than an adhesive backing sheet may be removed from the eye pad (413) and pressed against the top cover (204) of the mouse for secure joining and mounting of the assembly. The vertical portion of the control fin is approximately ¾″ high, with a width of ⅞″, and a thickness of ⅛″. Attached to, and made part of the vertical fin, is a horizontal pad extending equally on each side consisting of a ⅞″ square, with a thickness of not more than ⅛″, to which the mounting Velcro™ hook and eye pads are attached.

Description of Embodiment—Removable Guide Fin—Snap-On

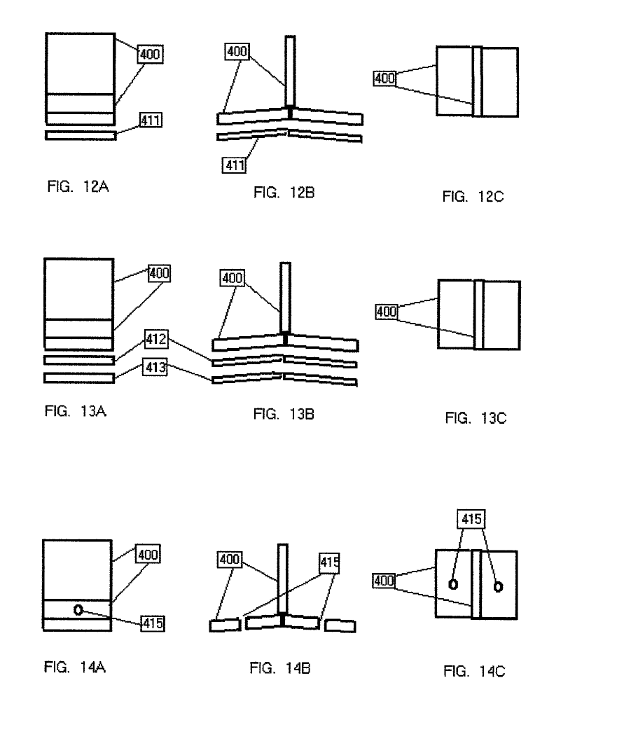

FIGS. 14A-C illustrates the basic design of control fin (400) with prepared proper sized holes (415) to enable the installation of the control fin to the top cover (204) and the integral molded pegs (401). The vertical portion of the control fin is approximately ¾″ high, with a width of ⅞″, and a thickness of ⅛″. Attached to, and made part of the vertical fin, is a horizontal pad extending equally on each side consisting of a ⅞″ square, with a thickness of not more than ⅛″, through which the mounting ‘snap-on’ 3/32″ diameter holes, spaced approximately ⅝″ apart, are drilled or punched.

What is claimed is:

1. A computer system comprised of
at least one microprocessor;
a monitor;
a mouse having a guide fin such that the guide fin may be positioned between two fingers of a computer user's first hand such that the first hand may move the mouse without clasping fingers around the mouse, and such that the movement of the mouse causes a corresponding movement of a cursor on the monitor, the mouse having at least one input switch for providing commands to the microprocessor; and
a secondary switching mechanism such that at least one secondary switch may be operated remote from the mouse.

2. The computer system of claim 1 wherein
the mouse has a left button and a right button;
the secondary switching mechanism has a first switch, such that activating the first switch has the same control result as depressing the left button on the mouse; and
the secondary switching mechanism has a second switch, such that activating the second switch has the same control result as depressing the right button on the mouse.

3. The computer system of claim 1 wherein
the secondary switching mechanism may be held in a computer user's second hand.

4. The computer system of claim 1 wherein
the secondary switching mechanism is mounted in a bracket.

5. The computer system of claim 1 wherein
the secondary switching mechanism is in wireless communication with the computer.

6. An improved computer mouse, the improvement comprising
a guide fin such that the mouse may be moved by positioning the fin between two fingers of a computer users' first hand, and moving the first hand; and
a secondary switch means remote to the mouse such that the functions of clicking a mouse button may be accomplished by activating, without using the first hand, at least one switch on the secondary switch means.

7. The computer mouse of claim 6 wherein the guide fin is formed integral to the housing.

8. The computer mouse of claim 6 wherein the guide fin is attached to an existing mouse.

9. The computer mouse of claim 6 wherein
the guide fin is detachable from the mouse such that it may be installed or removed as desired.

10. The computer mouse of claim 6 wherein
the guide fin is comprised of at least one peg.

11. The computer mouse of claim 10 wherein
the guide fin is comprised of a plurality of removable pegs positioned on the mouse.

12. A guide fin kit, which may be attached to a computer mouse, the guide fin kit comprising
an essentially planar guide fin having a first surface and a second surface;
at least one support flap, such that the support flap may be positioned on the mouse at an angle with respect to the first surface of the guide fin; and
an adhesive to secure the support flap to the mouse such that the fin is positioned essentially vertical with respect to the top of the mouse.

13. The guide fin kit of claim 12 comprising
a first support flap, which may be positioned at an angle relative to the first surface of the guide fin;
a second support flap which may be positioned at an angle relative to the second surface of the guide fin; and
a pre-applied adhesive applied to the bottom surface of the first support flap and to the bottom surface of the second support flap

14. The guide fin kit of claim 12 further comprising
a secondary switching means such that the function of at least one mouse button may be performed by activating the secondary switching means.

15. The guide fin kit of claim 14 wherein
the secondary switching means communicates wirelessly to at least one control circuit between the mouse and a computer.

16. The guide fin kit of claim 12 wherein
Velcro™ is applied to a portion of the top of the mouse; and
Velcro™ is applied to the bottom of the support flap such that the guide fin may be removably attached to the mouse by attaching the support flap to the Velcro™ in the top of the mouse.

17. A selection and control method for a computer system, the method comprising
placing a first hand upon a mouse such that a mouse guide fin is positioned between two fingers of the first hand;
guiding the position of a cursor on a computer monitor to a desired location on the monitor by moving the hand, thereby pushing the guide fin and moving the mouse; and
upon proper positioning of the cursor, causing a control signal to be issued to the computer by either activating a button on the mouse by clicking at least one time with a portion of the first hand, or by activating a switch means on a secondary switching device.

18. The selection and control method of claim 17 wherein,
causing a control signal to be issued is accomplished by activating a switch on a hand-held secondary switching device.

19. The selection and control method of claim 17 wherein,
causing a control signal to be issued is accomplished by activating a bracket-mount switch.

20. The selection and control method of claim 17 wherein,
causing a control signal to be issued is accomplished by voice command.
